(19) United States
(12) Patent Application Publication
(10) Pub. No.: US 2016/0260450 A1
(43) Pub. Date: Sep. 8, 2016

(54) MAGNETIC DISK DEVICE AND CONTROL METHOD

(71) Applicant: Kabushiki Kaisha Toshiba, Tokyo (JP)

(72) Inventor: Akihiro Harigae, Fujisawa Kanagawa (JP)

(21) Appl. No.: 14/807,133

(22) Filed: Jul. 23, 2015

Related U.S. Application Data
(60) Provisional application No. 62/128,343, filed on Mar. 4, 2015.

(51) Int. Cl. G11B 5/596

(52) U.S. Cl. CPC G11B 5/596

(57) ABSTRACT

According to one embodiment, there is provided a magnetic disk device including a magnetic head and a controller. The magnetic head includes a write head and a read head. The controller is configured to measure a difference amount for each of a first track and a second track near the first track on a magnetic disk. The difference amount is a difference between an actual read/write offset and a read/write offset set as an amount corresponding to a distance between the write head and the read head in a cross track direction. The controller is configured to identify a track having an abnormal track pitch based on the measured difference amount.

### CROSS-REFERENCE TO RELATED APPLICATIONS

This application is based upon and claims the benefit of priority from U.S. Provisional Application No. 62/128,343, filed on Mar. 4, 2015; the entire contents of which are incorporated herein by reference.

### FIELD

Embodiments described herein relate generally to a magnetic disk device and a control method.

### BACKGROUND

A magnetic disk in a magnetic disk device tends to have a narrow track pitch in order to increase the density of data stored in the magnetic disk. It is thus desired to manage a track pitch abnormally (a spot having a different track pitch from the vicinity thereof).

### BRIEF DESCRIPTION OF THE DRAWINGS

FIG. 1 is a block diagram illustrating a configuration of a magnetic disk device according to an embodiment;

FIG. 2 is a diagram illustrating read/write offset management information according to the embodiment;

FIG. 3 is a diagram illustrating offset deviation when all of a plurality of tracks with which a virtual line segment connecting a read head and a write head of the embodiment overlaps have a normal pitch;

FIG. 4 is a diagram illustrating offset deviation when a track with an abnormal pitch is included in a plurality of tracks with which the virtual line segment connecting the read head and the write head of the embodiment overlaps;

FIG. 5 is a flowchart illustrating an operation of the magnetic disk device according to the embodiment;

FIG. 6 is a diagram illustrating a data structure of write count management information according to the embodiment;

FIG. 7 is a diagram illustrating a data structure of offset read processing management information according to the embodiment;

FIG. 8 is a diagram illustrating a data structure of refresh threshold management information according to the embodiment;

FIG. 9 is a flowchart illustrating processing performed in a test mode according to the embodiment;

FIG. 10 is a flowchart illustrating processing of identifying a track with an abnormal pitch according to the embodiment;

FIGS. 11A and 11B are diagrams illustrating the processing of identifying the track with the abnormal pitch according to the embodiment;

FIGS. 12A and 12B are diagrams illustrating the processing of identifying the track with the abnormal pitch according to the embodiment;

FIG. 13 is a diagram illustrating the processing of identifying the track with the abnormal pitch according to the embodiment;

FIG. 14 is a diagram illustrating a data structure of abnormal pitch management information according to the embodiment;

FIG. 15 is a diagram illustrating a data structure of refresh threshold reconfiguring information according to the embodiment;

FIGS. 16A and 16B are diagrams illustrating processing of identifying a plurality of tracks with an abnormal pitch according to a variation of the embodiment; and

FIG. 17 is a diagram illustrating a data structure of refresh threshold reconfiguring information according to the variation of the embodiment.

### DETAILED DESCRIPTION

In general, according to one embodiment, there is provided a magnetic disk device including a magnetic head and a controller. The magnetic head includes a write head and a read head. The controller is configured to measure a difference amount for each of a first track and a second track near the first track on a magnetic disk. The difference amount is a difference between an actual read/write offset and a read/write offset set as an amount corresponding to a distance between the write head and the read head in a cross track direction. The controller is configured to identify a track having an abnormal track pitch based on the measured difference amount.

Exemplary embodiments of a magnetic disk device will be explained below in detail with reference to the accompanying drawings. The present invention is not limited to the following embodiments.

### Embodiments

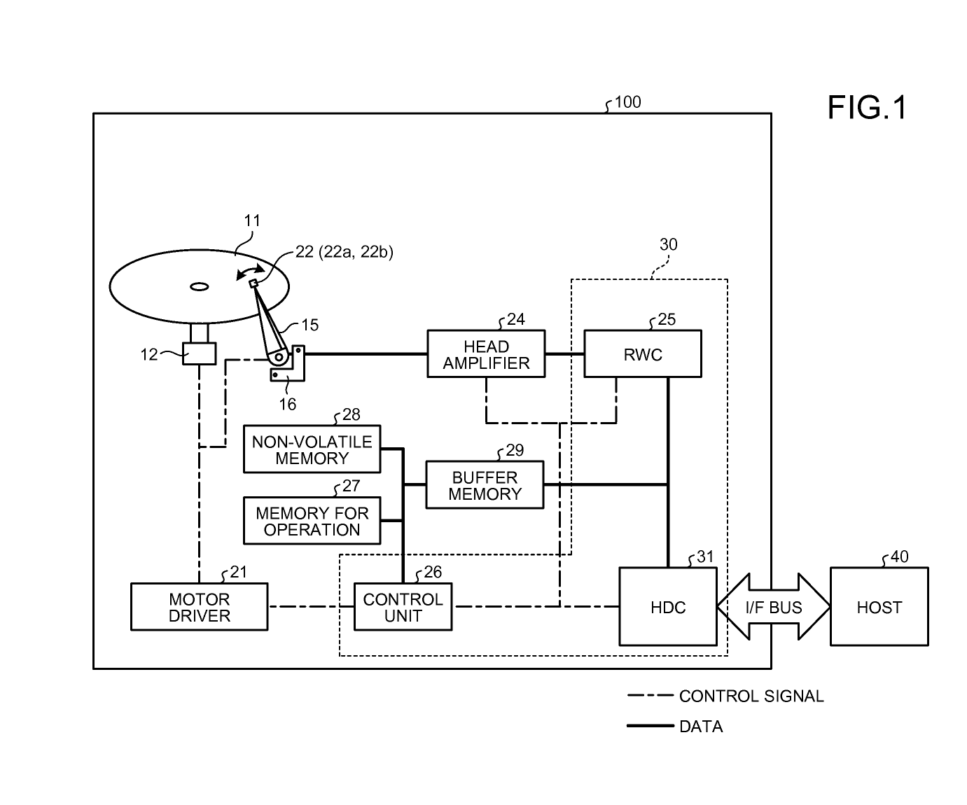

A disk device 100 according to an embodiment will be described with reference to FIG. 1. FIG. 1 is a diagram illustrating a configuration of the disk device 100.

The disk device 100 is a device (such as a magnetic disk device or a hard disk device) which records information on a magnetic disk 11 through a magnetic head 22 and reads a signal from the magnetic disk 11 through the magnetic head 22, for example. Specifically, the disk device 100 includes the magnetic disk 11, a spindle motor (SPM) 12, a motor driver 21, the magnetic head 22, an actuator arm 15, a voice coil motor (VCM) 16, a head amplifier 24, a read/write channel (RWC) 25, a hard disk controller (HDC) 31, a buffer memory 29, and a control unit 26.

The SPM 12 rotates the magnetic disk 11 about an axis of rotation at a predetermined rotational speed. The SPM 12 is rotationally driven by the motor driver 21.

A write head 22a and a read head 22b included in the magnetic head 22 write and read data to/from the magnetic disk 11. Moreover, the VCM 16 driven by the motor driver 21 moves the magnetic head 22, which is at the tip of the actuator arm 15, along a radial direction (cross track direction) of the magnetic disk 11.

The head amplifier 24 amplifies/outputs the signal read from the magnetic disk 11 by the magnetic head 22, and supplies the signal to the RWC 25. The head amplifier 24 also amplifies a signal supplied from the RWC 25 and used to write data to the magnetic disk 11, and supplies the signal to the magnetic head 22.

The HDC 31 controls transmission/reception of data to/from a host computer 40 through an I/F bus, controls the buffer memory 29, and performs error correction on write data. The buffer memory 29 is used as a cache for the data transmitted/received to/from the host computer 40. The buffer memory 29 is also used to temporarily store data read from the magnetic disk 11, data written to the magnetic disk 11, or control firmware read from the magnetic disk 11. The buffer memory 29 is a DRAM or an SDRAM, for example.

The RWC 25 performs code modulation on data supplied from the HDC 31 to be written onto the magnetic disk 11, and supplies the data to the head amplifier 24. The RWC 25 also performs code demodulation on a signal read from the magnetic disk 11 and supplied through the head amplifier 24, and outputs the signal as digital data to the HDC 31.

Connected to the control unit 26 includes a memory for operation 27 (such as an SRAM: Static Random Access Memory), a non-volatile memory 28 (such as a Flash ROM: Flash Read Only Memory), and the buffer memory 29 used for temporary storage. The control unit 26 performs overall control on the magnetic disk device 100 according to firmware stored in advance in the non-volatile memory 28 or the magnetic disk 11. The firmware includes initial firmware and the control firmware used in a normal operation. The initial firmware executed first at start-up is stored in the non-volatile memory 28, for example, while the control firmware used in the normal operation is recorded in the magnetic disk 11. Under control according to the initial firmware, data is once read to the buffer memory 29 from the magnetic disk 11 and then stored in the memory for operation 27.

The control unit 26 includes a normal mode and a test mode as control modes, for example. The normal mode is a mode of writing and reading data to/from the magnetic disk 11. The test mode is a mode of measuring the quality of a read signal (measuring an error rate, for example) and identifying a track with an abnormal pitch.

It should be noted that a configuration including the RWC 25, control unit 26, and HDC 31 can be treated as a controller 30 as well.

Each of a plurality of tracks provided concentrically on the magnetic disk 11 of the disk device 100 is assigned with a track number ordered from an inner side of the disk to an outer side thereof or from the outer side to the inner side. The magnetic disk device 100 has a refresh threshold (trigger condition) set for each management unit such as a track or a zone including a plurality of tracks.

In the normal mode, the magnetic disk device 100 uses the magnetic head 22 to record data onto a track of the magnetic disk 11 and manages a write count for each management unit (for each track, for example). The magnetic disk device 100 then performs refresh processing on the management unit having the write count greater than or equal to the refresh threshold, the refresh processing using the magnetic head 22 to rewrite data. A track with a locally narrow track pitch tends to be largely affected by write performed onto an adjacent track with a fewer number of write count compared to a track with a normal track pitch. When the refresh threshold of the track is set to the same value as that of the track with the normal track pitch, there is an increased chance of side erase occurring before performing the refresh processing on that track. As a result, a read operation of the magnetic disk device 100 performed in the normal mode is more likely to result in a read error. Moreover, the track pitch in the magnetic disk device 100 tends to be narrow in order to increase the density of data stored in the magnetic disk 11. It is therefore desired to manage a track pitch anomaly (a track having a narrower track pitch than a neighboring track).

The track pitch is determined in a manufacturing process of the magnetic disk device 100 while depending upon a pitch in servo information of the magnetic disk 11. While the servo information is ideally written at a constant feed pitch when written onto the magnetic disk 11, for example, a source of error such as unstable rotation of the VCM 16, the way a servo information recording device brings a pin into contact with the magnetic disk 11, and a surrounding environment (vibration and shock) causes a nonuniform track pitch in writing the servo information. A non-negligible track pitch anomaly occurs when the source of error gets large.

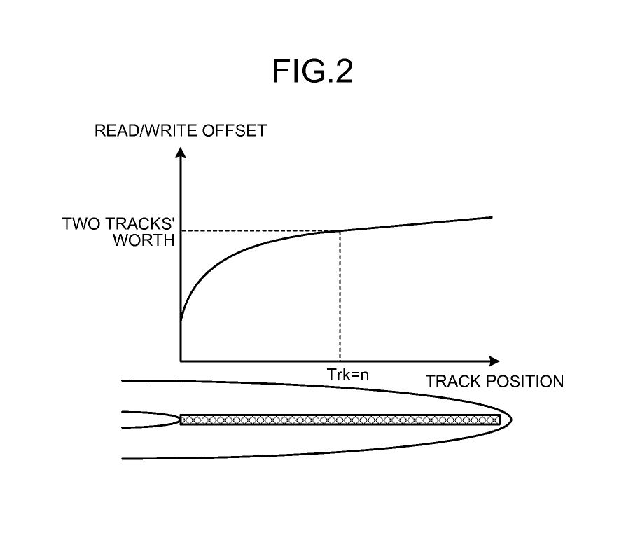

One needs to grasp a read/write offset that is a relative distance between the read head 22b and the write head 22a in a cross track direction in order to grasp the track pitch anomaly. However, the arm angle of the actuator arm 15 changes as a track on the magnetic disk 11 is located closer to an inner circumference or an outer circumference of the disk, whereby a skew angle of the magnetic head 22 changes as well. This causes a change in the relative positional relationship between the read head 22b and the write head 22a with respect to the magnetic disk 11 so that the read/write offset changes. The offset successively changes in the range of±several tracks from the outer circumference toward the inner circumference of the magnetic disk 11, for example. Accordingly, calibration processing is performed in the manufacturing process of the magnetic disk device 100 to calculate the read/write offset for each track. An adjacent track is highly likely to have about the same read/write offset, and thus a read/write offset of a representative track is measured for each particular zone to interpolate the measured read/write offset of the representative track by using an approximation curve, for example. As a result, as illustrated in FIG. 2, the read/write offset can be calculated for each track. The calculated read/write offset is an amount indicating how many tracks the distance between the read head 22b and the write head 22a in the cross track direction corresponds to, for example. Information of the read/write offset calculated for each track is stored as read/write offset management information as illustrated in FIG. 2. The read/write offset management information is stored in a management information storage region of the magnetic disk 11 before shipment of the magnetic disk device 100. The controller 30 reads the read/write offset management information from the management information storage region on the magnetic disk 11 as needed to be able to acquire the read/write offset configured in the manufacturing process.

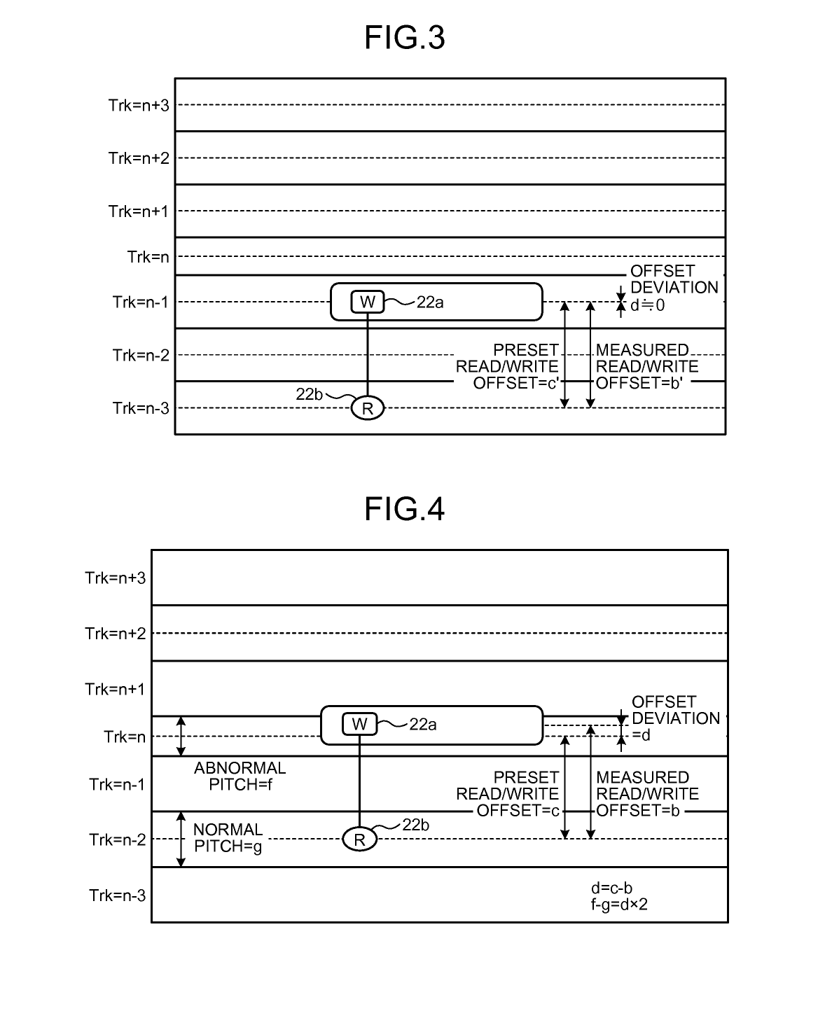

The configured read/write offset is measured from the representative track of each zone and is possibly different from a read/write offset of an actual track. It is assumed that a read/write offset set in advance for tracks “n−1” and “n” illustrated in FIGS. 3 and 4 corresponds to two tracks, for example. An integer of 4 or larger is set to “n”.

FIG. 3 illustrates an offset deviation when all of a plurality of tracks “n−3” to “n−1” with which a virtual line segment connecting the read head 22b and the write head 22a overlaps have a normal pitch. When data is written to the track “n−1”, the read head 22b is positioned at a position that is off-set from the center of the track “n−1” according to a preset read/write offset. That is, the read head 22b is positioned at the center of the track “n−3” as the position that is off-set by the preset read/write offset (=two tracks) from the center of the track “n−1”. This allows the write head 22a to write the data to the center of the track “n−1”. An actual read/write offset b′ can then be measured when the read head 22b reads and confirms the data written to the center of the track “n−1”. Here, an offset deviation d between a read/write offset c′ preset in the manufacturing process and the read/write offset b′ actually measured is approximately zero.

FIG. 4 illustrates an offset deviation when a plurality of tracks “n−2” to “n” with which the virtual line segment connecting the read head 22b and the write head 22a overlaps includes a track (track “n”) with an abnormal pitch. When data is written to the track “n”, the read head 22b is positioned at a position that is off-set from the center of the track “n” according to a preset read/write offset. That is, the read head 22b is positioned at the center of the track “n−2” as the position that is off-set by the preset read/write offset (=two tracks) from the center of the track “n”. However, the track pitch of the track “n” is narrower than a normal pitch, so that the write head 22a writes the data to a position deviated from the center of the track “n” by the offset deviation d. An actual read/write offset b can then be measured when the read head 212b reads and confirms the data written to the position deviated from the center of the track “n” by the offset deviation d. Here, the offset deviation between a read/write offset c preset in the manufacturing process and the read/write offset b actually measured equals a value d smaller than zero, as indicated by expression 1.

d=c−b Expression 1

Where “f” denotes an abnormal pitch and “g” denotes a normal pitch, as illustrated in FIG. 4, a difference between the abnormal pitch f and the normal pitch g is calculated by the following expression 2 while using the offset deviation (d), for example.

f−g=d×2 Expression 2

As indicated by expressions 1 and 2, the offset deviation d has a negative value when the abnormal pitch f is narrower than the normal pitch g. One can thus grasp the track pitch anomaly on the basis of the offset deviation d between the read/write offset c preset in the manufacturing process and the read/write offset b that is actually measured.

Now, the magnetic disk device 100 of the present embodiment identifies a site of the track pitch anomaly by measuring the offset deviation between the read/write offset preset in the manufacturing process and the read/write offset actually measured, and reconfigures an appropriate refresh threshold to the identified track. This allows the magnetic disk device 100 to avoid the read error generated by the delay of the refresh processing. There will now be illustrated a case where each track is set as the management unit.

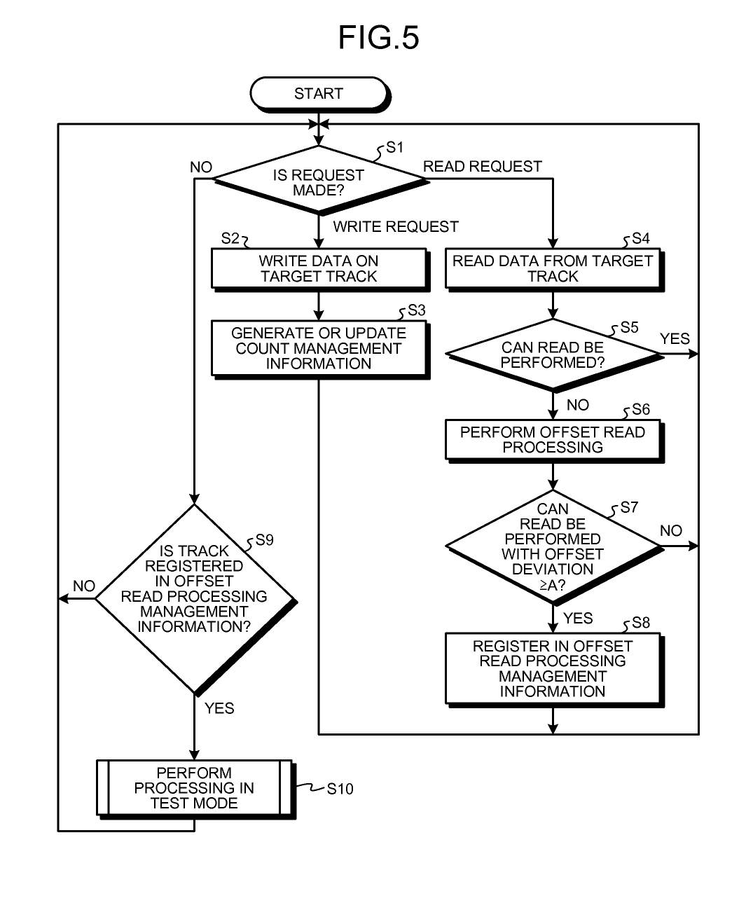

Specifically, the magnetic disk device 100 of the present embodiment performs an operation illustrated in FIG. 5. FIG. 5 is a flowchart illustrating the operation of the magnetic disk device 100.

The controller 30 determines whether or not a request is made from the host computer 40 (S1).

When receiving a write request and write data from the host computer 40 (“write request” in S1), the controller 30 uses the magnetic head 22 to write the write data into a sector of a target track according to the write request (S2). Then, the controller 30 generates or updates write count management information 27a (S3).

The write count management information 27a manages the number of data writes performed by the magnetic head 22 for each management unit (such as a track). The controller 30 generates the write count management information 27a and stores it into the memory for operation 27 when the write count management information 27a is not already stored in the memory for operation 27. The controller 30 performs an update by incrementing the write count for the management unit onto which the data is recorded, when the write count management information 27a is already stored in the memory for operation 27.

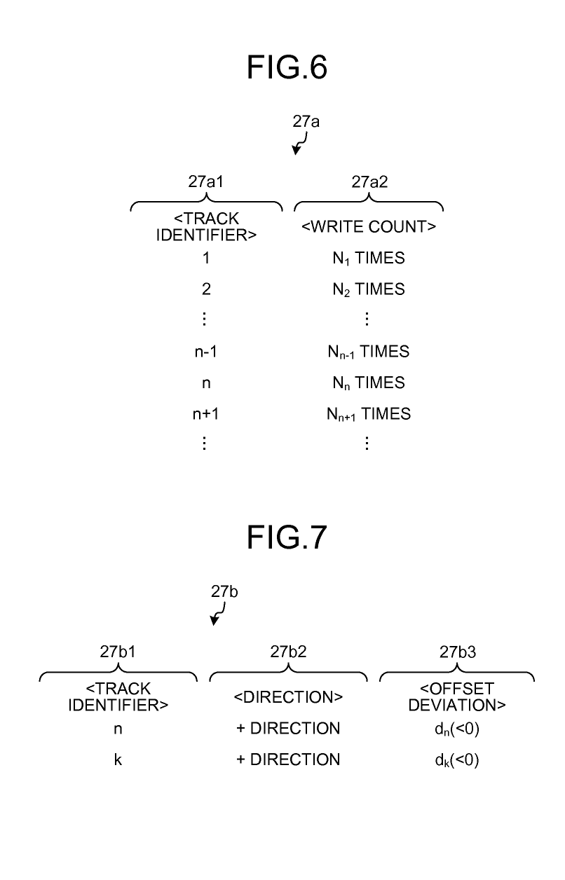

The write count management information 27a has a data structure illustrated in FIG. 6, for example. The write count management information 27a includes a track identifier column 27a1 and a write count column 27a2. An identifier of a track (such as a track number) is recorded under the track identifier column 27a1. A write count of data is recorded under the write count column 27a2. One can see that the write count of the track “n” is Nₙ by referring to the write count management information 27a, for example. An integer of 4 or larger is set to “n”. The similar can be said of another track.

The controller 30 returns to the processing in S1 upon completing the generation or update of the write count management information 27a.

When receiving a read request from the host computer 40 (“read request” in S1), the controller 30 uses the magnetic head 22 to reproduce data in a target track according to the read request (S4). The controller 30 reads the data by positioning the read head 212b of the magnetic head 22 at the center of the target track, for example. The controller 30 then determines whether or not the data read is successfully performed, namely the read can be performed (S5).

The controller 30 determines that the read can be performed (“Yes” in S5) and returns to the processing in S1 when the data read is performed successfully, for example. The controller 30 determines that the read cannot be performed (“No” in S5) and proceeds to processing in S6 when the data read is not performed successfully.

The controller 30 performs offset read processing upon determining that the read cannot be performed (S6). The offset read processing is the processing of changing the offset deviation in the cross track direction from the center of the track and causing the read head 212b to read data in a sector of that track. In other words, the offset read processing is the processing of searching for a read position at which the read can be performed while changing the read/write offset by the offset deviation. For each sector, the controller 30 for example reiterates processing of changing the offset deviation by a predetermined amount in the cross track direction and processing of evaluating whether or not the read can be performed. The cross track direction includes a ‘+ direction’ into which the track number increases and a ‘− direction’ into which the track number decreases, for example. When the track number is assigned to each of the plurality of tracks on the magnetic disk 11 in the order from the track on the outer side to the track on the inner side of the disk, for example, the ‘+ direction’ is oriented toward the center of the magnetic disk 11 whereas the ‘− direction’ is oriented away from the center of the magnetic disk 11. When the track number is assigned to each of the plurality of tracks on the magnetic disk 11 in the order from the track on the inner side to the track on the outer side of the disk, the ‘+ direction’ is oriented away from the center of the magnetic disk 11 whereas the ‘− direction’ is oriented toward the center of the magnetic disk 11. The controller 30 thereafter determines for each offset position whether or not the quality of a reproduction signal satisfies a standard.

When there is found a read position with some offset deviation at which the read can be performed, the controller 30 perceives the target track can be relieved by the offset read processing.

When there is not found a read position at which the read can be performed (when the offset deviation reaches a limit), the controller 30 perceives the target track cannot be relieved by the offset read processing. The limit is set to half the normal pitch (refer to FIG. 4), for example.

Here, a track with a small offset deviation among the tracks that can be relieved by the offset read processing is less likely to have an abnormal pitch or has a light pitch anomaly. The controller 30 thus determines whether or not the offset deviation of the read position at which the read can be performed upon execution of the offset read processing is larger than or equal to a threshold A (S7). The threshold A is an amount larger than zero but smaller than the limit. When the offset deviation is smaller than the threshold A (“No” in S7), the controller 30 regards the track as being less likely to have the abnormal pitch and returns to the processing in S1.

When the offset deviation is larger than or equal to the threshold A (“Yes” in S7), the controller 30 regards the target track as possibly having the abnormal pitch and registers the target track in offset read processing management information 27b (S8). The offset read processing management information 27b is information provided to manage the result of the offset read processing for each management unit. The controller 30 generates the offset read processing management information 27b and stores it into the memory for operation 27 when the offset read processing management information 27b is not already stored in the memory for operation 27. When the offset read processing management information 27b is already stored in the memory for operation 27, the controller 30 overwrites and updates information of the management unit on which the offset read processing is performed with the threshold A or larger.

The offset read processing management information 27b has a data structure illustrated in FIG. 7, for example. The offset read processing management information 27b includes a track identifier column 27b1, a direction column 27b2, and an offset deviation column 27b3. An identifier of a track (such as a track number) is recorded under the track identifier column 27b1. An offset direction in which the read is enabled by the offset read processing is recorded under the direction column 27b2. An amount deviated (offset deviation) in the cross track direction from the center of the track in the offset read processing is recorded under the offset deviation column 27b3. The offset deviation for the track can be an average amount or a maximum amount of the offset deviations of a plurality of sectors included in that track. One can see by referring to the offset read processing management information 27b that the track “n” can be relieved by the offset read processing, an appropriate read position of which is offset from the center of the track by an offset deviation dₙ (<0) in the +direction.

Referring back to FIG. 5, the controller 30 returns to the processing in S1 upon completing the registration of the target track into the offset read processing management information 27b.

When a request from the host computer 40 is not received for a predetermined period (“No” in S1), the controller 30 determines whether or not there is a track registered in the offset read processing management information 27b (S9).

The controller 30 returns to the processing in S1 when no track is registered in the offset read processing management information 27b (“No” in S9).

When there is a track registered in the offset read processing management information 27b (“Yes” in S9), on the other hand, the controller 30 causes the operation mode to transition from the normal mode to the test mode and performs processing in the test mode (S10). Upon completing the processing in the test mode, the controller 30 reconfigures the operation mode from the test mode to the normal mode and returns to the processing in S1.

When a plurality of tracks is registered in the offset read processing management information 27b, for example, the track with the write count closer to the refresh threshold is given priority to be subjected to the processing in the test mode. The controller 30 refers to the count management information 27a and refresh threshold management information 27c to determine a degree of leeway to reach the refresh threshold (trigger condition), or how close the write count is to the refresh threshold.

The refresh threshold management information 27c is information provided to manage, for each management unit, the write count (namely the refresh threshold) being a threshold at which the refresh processing is to be performed in the normal mode. The controller 30 generates the refresh threshold management information 27c and stores it into the memory for operation 27 when the refresh threshold management information 27c is not already stored in the memory for operation 27. At this time, the controller 30 reads a default refresh threshold Nth (such as 2000 times) from the management information storage region on the magnetic disk 11 and sets the threshold as the refresh threshold for each management unit.

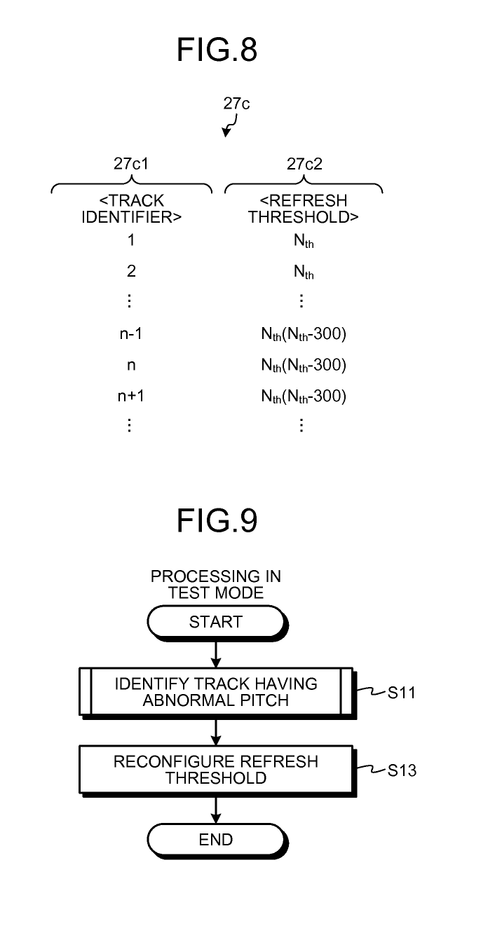

The refresh threshold management information 27c has a data structure illustrated in FIG. 8, for example. The refresh threshold management information 27c includes an identifier column 27c1 and a refresh threshold column 27c2. An identifier of a track (such as a track number) is recorded under the identifier column 27c1. A write count being a threshold at which the refresh processing is to be performed, namely the refresh threshold, is recorded under the refresh threshold column 27c2. One can see by referring to the refresh threshold management information 27c that the default refresh threshold Nth is included in the refresh threshold for each track, for example.

The controller 30 calculates a difference AN obtained by subtracting the write count from the refresh threshold for each management unit. The controller 30 can determine how close the write count is to the refresh threshold (trigger condition) according to the difference AN. The controller 30 sets higher closeness CD2 for a second difference AN2 than closeness CD1 for a first difference AN1, for example. An absolute value of the second difference AN2 is smaller than an absolute value of the first difference AN1. The controller 30 can perform the processing in the test mode on the plurality of tracks registered in the offset read processing management information 27b in order from the one having the higher closeness. The controller 30 performs the processing in the test mode preferentially on the track with the closeness CD2 over the track with the closeness CD1, for example.

Alternatively, when the plurality of tracks is registered in the offset read processing management information 27b, the processing in the test mode is performed on the tracks in the order from the one having a larger absolute value of the offset deviation in the offset read processing management information 27b, for example. In the example illustrated in FIG. 7, for example, the controller 30 preferentially performs the processing in the test mode on the track “n” over a track “k” when an absolute value of an offset deviation d₀ is larger than an absolute value of an offset deviation dₖ.

Specifically, the controller 30 performs processing illustrated in FIG. 9 as the processing in the test mode in step S10 of FIG. 5. FIG. 9 is a flowchart illustrating the processing performed in the test mode.

That is, the controller 30 selects any of the tracks registered in the offset read processing management information 27b as a track of interest and measures a read/write offset of the track of interest. The controller 30 finds, for the track for which the read/write offset is measured, the offset deviation (difference amount) between the read/write offset preset in the manufacturing process and the read/write offset that is actually measured. In other words, the controller 30 measures the offset deviation. The controller 30 performs this processing of measuring the offset deviation on the track (track of interest) registered in the offset read processing management information 27b as well as a neighboring track. The controller 30 identifies a track with an abnormal track pitch according to the offset deviation measured for each track (S11).

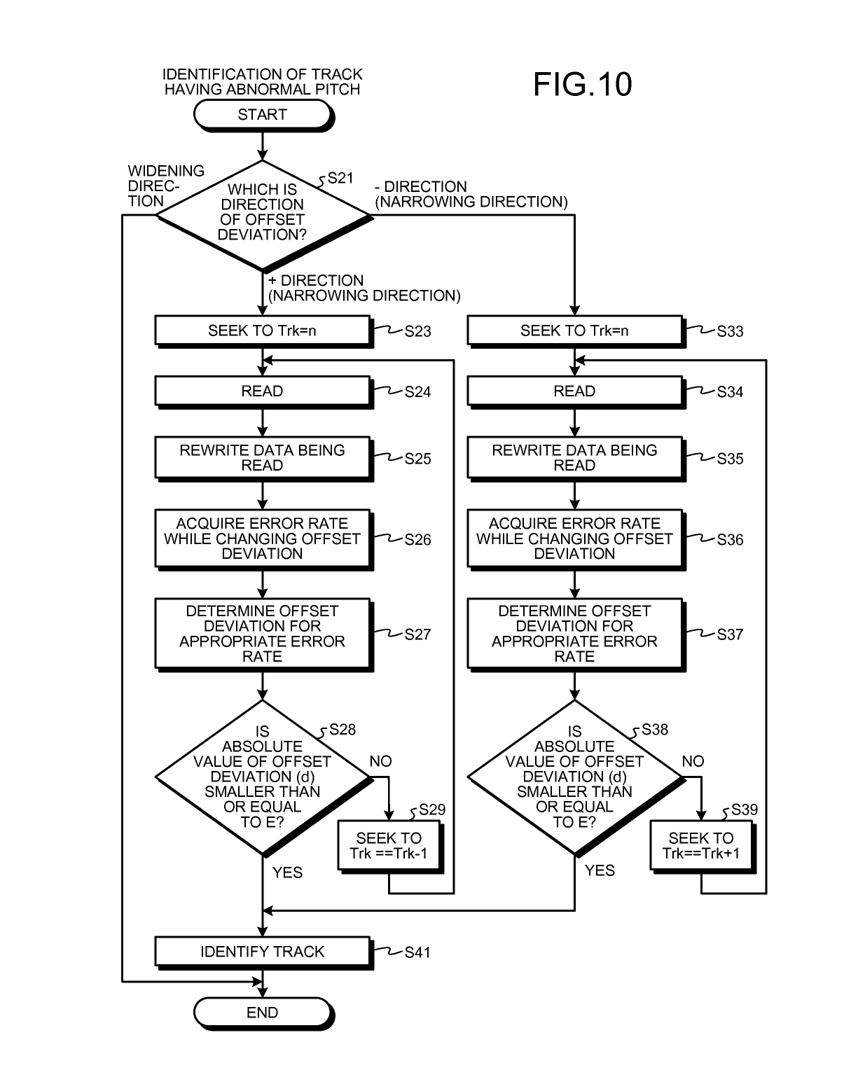

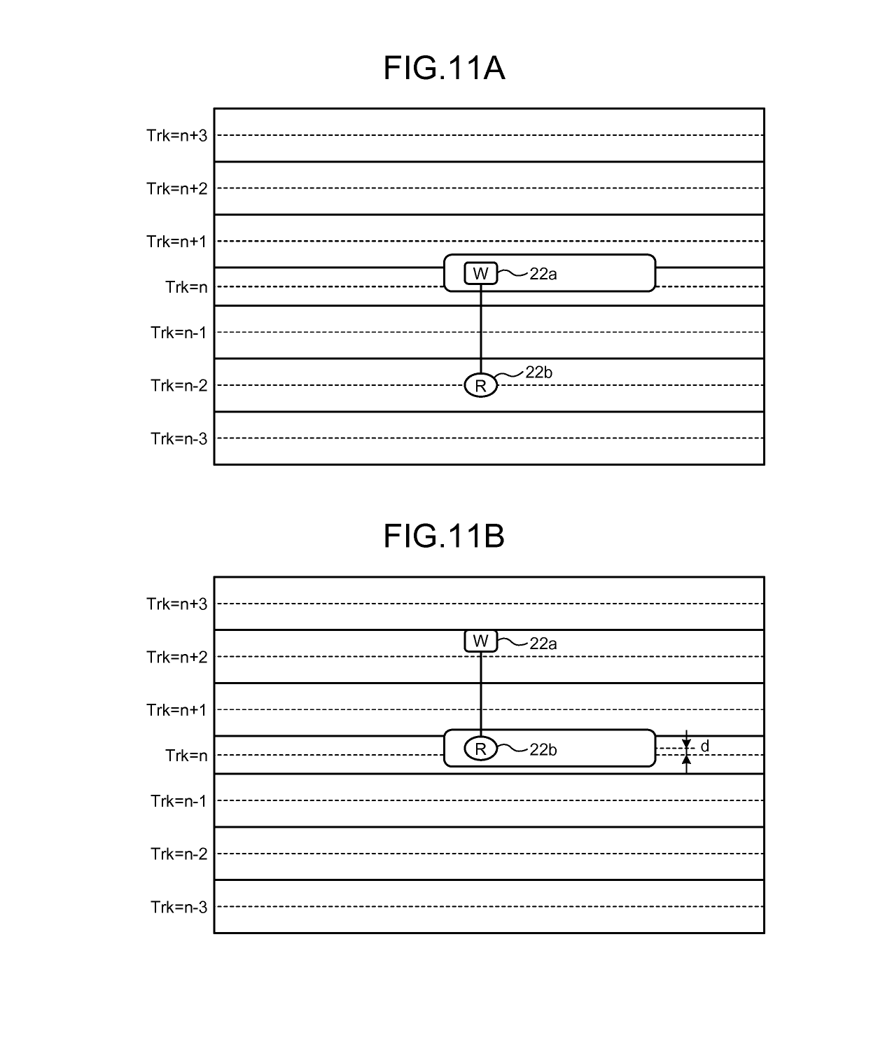

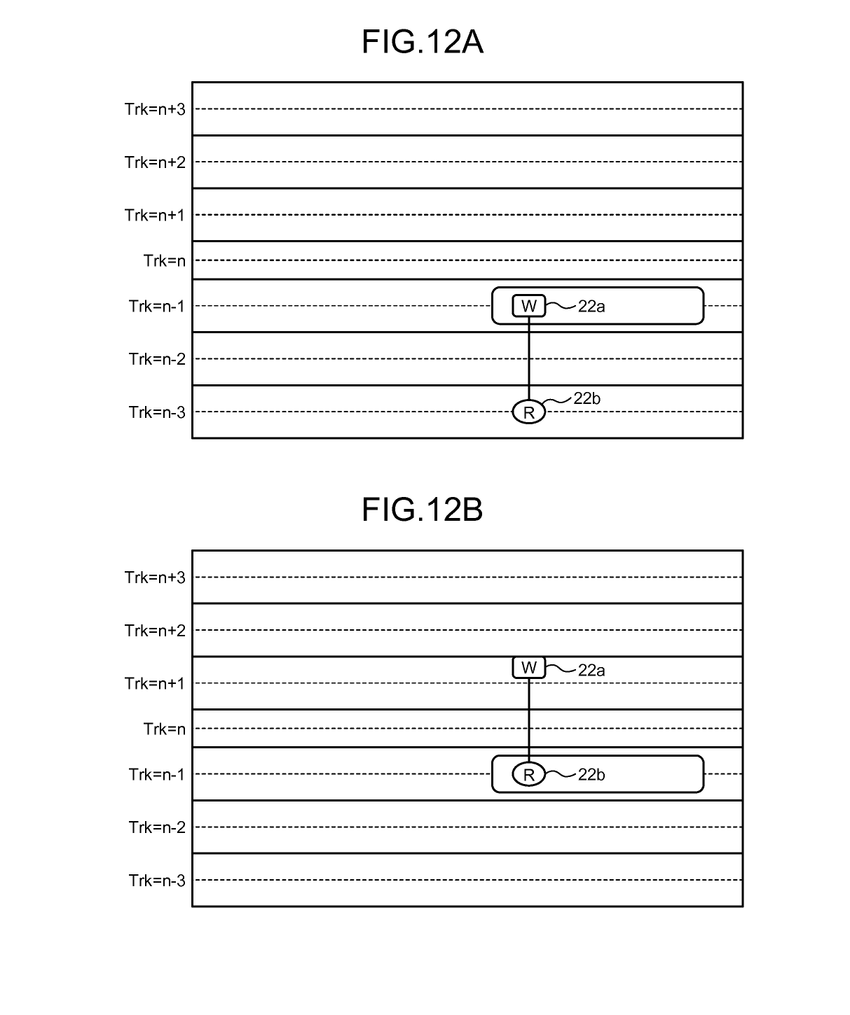

More specifically, the controller 30 performs processing illustrated in FIGS. 10 to 12. FIG. 10 is a flowchart illustrating processing of identifying the track with the abnormal pitch. FIGS. 11 and 12 are diagrams schematically illustrating the processing of identifying the track with the abnormal pitch.

A track possibly has a track pitch anomaly when the track includes a sector that can be read with the offset deviation larger than or equal to the threshold (A) in the offset read processing performed in the normal mode. Accordingly, the controller 30 selects a track (track of interest) on which the processing in the test mode is to be performed from among the tracks registered in the offset read processing management information 27b. Note that all the tracks registered in the offset read processing management information 27b are tracks that can be read with the offset deviation larger than or equal to the threshold (A).

The controller 30 determines for the selected track an direction of the offset deviation in the offset read processing (S21). Four kinds of offset directions can be considered when the ‘+ direction’ corresponds to a direction in which the track number increases along the cross track direction while the ‘− direction’ corresponds to a direction in which the track number decreases along the cross track direction. The offset direction can also be considered as the indication of a direction of deviation (refer to FIG. 4) of an inter-track distance between the plurality of tracks to be measured from a reference distance.

The track pitch of the selected track is possibly narrower than a reference track pitch when the ‘+ direction’ is oriented from the read head 212b toward the write head 22a and the offset direction corresponds to the ‘+ direction’ as illustrated in FIG. 11B, for example. The offset direction of the track “n” corresponds to the ‘+ direction’ in the offset read processing management information 27b illustrated in FIG. 7, for example. In this case, the controller 30 determines the offset direction to be the “+ direction (narrowing direction)” and proceeds to processing in S23.

On the other hand, the track pitch of the selected track is possibly narrower than the reference track pitch when the ‘− direction’ is oriented from the read head 212b toward the write head 22a and the offset direction corresponds to the ‘− direction’. In this case, the controller 30 determines the offset direction to be the “− direction (narrowing direction)” and proceeds to processing in S33.

Alternatively, the track pitch of the selected track is possibly wider than the reference track pitch when one of the direction oriented from the read head 212b toward the write head 22a and the offset direction corresponds to the ‘+ direction’ and the other one corresponds to the ‘− direction’. The side erase is less likely to occur in this case, so that the controller 30 determines the offset direction as a “widening direction” and ends the processing.

The controller 30 successively selects each of the plurality of tracks including the selected track as a track to be measured. The controller 30 then uses the write head 22a and rewrites data to the track to be measured. After that, the controller 30 measures the offset deviation according to the quality of a read signal obtained when the data is read while shifting the read head 212b in the cross track direction from the center of the track to be measured.

An ER (Error Rate), an SNR (Signal Noise Ratio), a VMM (Viterbi Metric Margin), an LLR (Log-Likelihood Ratio), or asymmetry can be used as the quality of the read signal, for example. There will be illustrated a case where the ER (Error Rate) is mainly used as the quality of the read signal.

A reference for the quality of the read signal is experimentally acquired in advance and recorded in a management information storage region of the magnetic disk 11. The controller 30 can acquire the reference for the quality of the read signal by accessing the management information storage region at the time of start-up or data read of the magnetic disk device 100.

There will be described an example where the track “n” is selected as the track to be measured, as illustrated in FIGS. 11A and 11B.

The controller 30 causes the read head 212b to seek to the track “n” (S23) and reads data recorded in the track “n” (S24). After that, the controller 30 performs positioning by causing the read head 22b to seek to a position (the center of a track “n−2” in the case illustrated in FIG. 11A) that is off-set by the preset read/write offset from the center of the track “n”. In this state, the controller 30 uses the write head 22a to rewrite the data recorded in the track “n” (S25). The data recorded in the track “n” is rewritten in order to eliminate the possibility that original data is affected by drift-off write or adjacent write. Note that backup data stored in advance in the non-volatile memory 28 or the memory for operation 27 at the time of recording data may be used as the data recorded in the track “n”.

As illustrated in FIG. 11B, the controller 30 performs positioning by causing the read head 212b to seek to the center of the track “n”. The controller 30 causes the read head 212b to read data written in the track “n” while shifting the read head 212b in the cross track direction from the center of the track “n” and changing the offset deviation. The controller 30 acquires the quality of the read signal (such as the error rate) when the data written in the track “n” is read by the read head (S26). The controller 30 finds an appropriate offset deviation (d) according to the quality of the read signal acquired. The controller 30 determines the offset deviation (d) at a position where the quality of the read signal is appropriate in the track “n”, for example (S27).

The controller 30 determines whether or not an absolute value of the appropriate offset deviation (d) is smaller than or equal to a threshold (E) (S28).

When the absolute value of the appropriate offset deviation (d) is larger than the threshold (E) (“No” in S28), the controller 30 shifts the track to be measured one track in the ‘− direction’, as illustrated in FIGS. 12A and 12B. The controller 30 determines a track “n−1” as the track to be measured when the track “n” is the current track to be measured, for example, and performs processing of steps S24 to S27 against the track “n−1”.

The controller 30 proceeds to step S41 when the absolute value of the appropriate offset deviation (d) is smaller than or equal to the threshold (E) (“Yes” in S28). That is, the controller 30 repeats the loop of steps S24 to S29 until the absolute value of the appropriate offset deviation (d) becomes smaller than or equal to the threshold (E).

It should be noted that processing performed in each of steps S33 to S39 is basically similar to the processing performed in each of steps S23 to S29 except that, in step S39, the track to be measured is shifted in the ‘+ direction’.

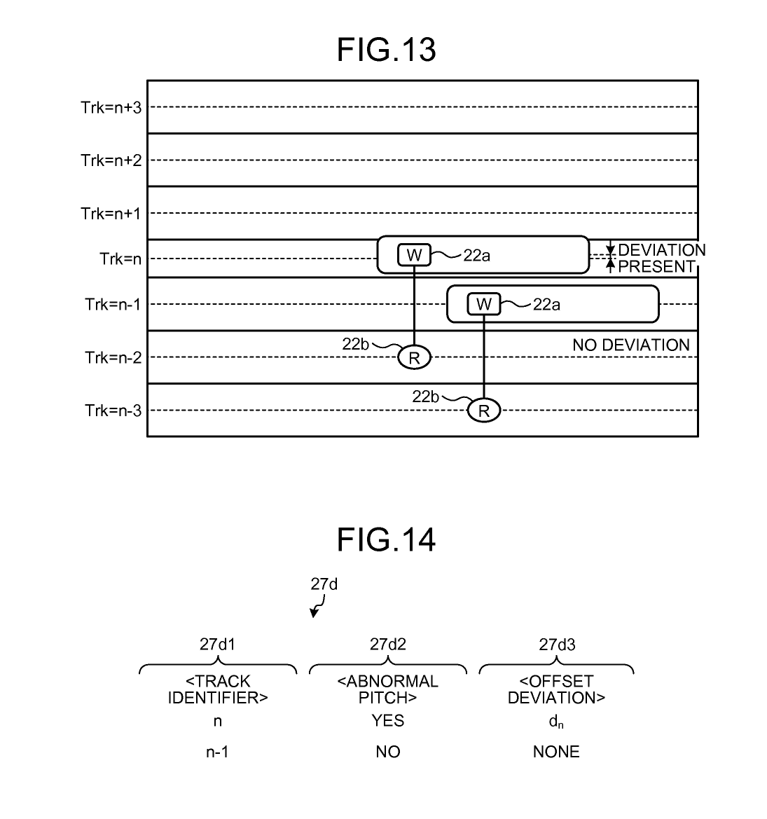

In step S41, the controller 30 identifies a track to/from which data is rewritten and read just before the absolute value of the appropriate offset deviation (d) becomes smaller than or equal to the threshold (E) as the track having an abnormal pitch. As illustrated in FIG. 13, for example, the controller 30 identifies the track “n” as the track having the abnormal pitch since the track “n” is the one to/from which the data is rewritten and read just before the absolute value of the appropriate offset deviation (d) becomes smaller than or equal to the threshold (E). FIG. 13 is a diagram illustrating a series of processing of FIGS. 11A to 12B put together.

The controller 30 then generates abnormal pitch management information 27d and stores it in the memory for operation 27. The abnormal pitch management information 27d is information provided to manage the abnormal pitch for each management unit.

The abnormal pitch management information 27d has a data structure illustrated in FIG. 14, for example. The abnormal pitch management information 27d includes a track identifier column 27d1, an abnormal pitch column 27d2, and an offset deviation column 27d3. An identifier of a track (such as a track number) is recorded under the track identifier column 27d1. Presence or absence of the abnormal pitch is recorded under the abnormal pitch column 27d2. An offset deviation of the track is recorded under the offset deviation column 27d3. One can see by referring to the abnormal pitch management information 27d that the track “n” has the abnormal pitch while another track “n−1” has a normal track pitch, for example. One can also see that the offset deviation of the track “n” equals dₙ. A track already measured is recorded in the abnormal pitch management information 27d to avoid measuring in the test mode many times over in the same track. In selecting the track (track of interest) on which the test mode is to be executed, the controller 30 refers to the abnormal pitch management information 27d to be able to select the track of interest by excluding the track already measured.

Referring back to FIG. 9, the controller 30 reconfigures the refresh threshold according to the offset deviation (S13). The controller 30 acquires refresh threshold reconfiguring information 28a by accessing the non-volatile memory 28 (or the management information storage region in the magnetic disk 11), for example. The controller 30 determines a reconfiguration amount corresponding to the offset deviation by referring to the refresh threshold reconfiguring information 28a.

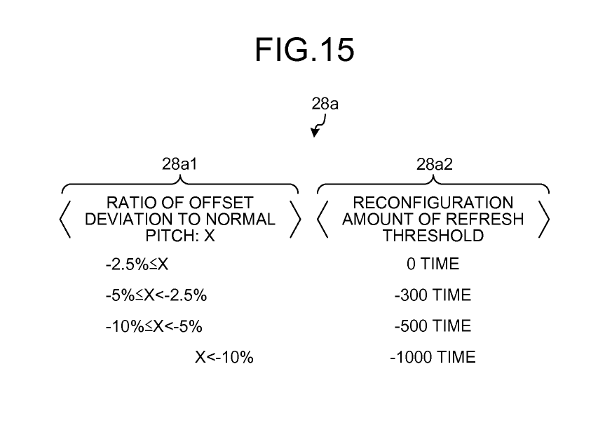

The refresh threshold reconfiguring information 28a is information used to manage the reconfiguration amount of the refresh threshold corresponding to the offset deviation. The refresh threshold reconfiguring information 28a has a data structure illustrated in FIG. 15, for example. The refresh threshold reconfiguring information 28a includes a column “ratio of offset deviation to normal pitch” 28a1 and a column “reconfiguration amount of refresh threshold” 28a2. A ratio of the offset deviation to the normal pitch in the track is recorded under the column “ratio of offset deviation to normal pitch” 28a1. An amount of change to be adopted when reconfiguring the refresh threshold is recorded under the column “reconfiguration amount of refresh threshold” 28a2.

One can see by referring to the refresh threshold reconfiguring information 28a that, for example, the refresh threshold is to be decreased by 300 times when the offset deviation of the track is −5% or larger and less than −2.5% with respect to the normal pitch (or when the track pitch is narrowed by 5 to 10% from the normal pitch).

The controller 30 accesses the refresh threshold management information 27c stored in the memory for operation 27 and reconfigures the refresh threshold with the determined reconfiguration amount. In addition to reconfiguring the refresh threshold of the track having the abnormal pitch, the controller 30 reconfigures a refresh threshold of each of tracks before and after the track having the abnormal pitch.

The controller 30 refers to the abnormal pitch management information 27d and grasps that the offset deviation of the track “n” equals dₙ, for example. The controller 30 finds the ratio of the offset deviation to the normal pitch (dₙ/g) and refers to the refresh threshold reconfiguring information 28a. Upon recognizing the ratio “−5% (dₙ/g) <−2.5%”, the controller 30 determines the reconfiguration amount to be “−300 times”. The controller 30 accesses the refresh threshold management information 27c and overwrites/updates the refresh threshold of the track “n” with “Nth−300” in place of “Nth”. Moreover, the controller 30 accesses the refresh threshold management information 27c and overwrites/updates the refresh threshold of each of the tracks “n−1” and “n+1” with “Nth−300” in place of “Nth”. The controller 30 as a result reconfigures the refresh threshold of the track “n” as well as the tracks “n−1” and “n+1” before and after the track “n” to “Nth−300”.

As described above, in the aforementioned embodiment, the controller 30 of the magnetic disk device 100 measures the offset deviation (difference amount) that is the difference between the read/write offset preset in the manufacturing process and the actual read/write offset for the track of interest as well as the neighboring track, and identifies the track having the abnormal track pitch on the basis of the measured offset deviation. Therefore, the track having the abnormal track pitch can be identified by each processing.

Moreover, in the aforementioned embodiment, the controller 30 of the magnetic disk device 100 performs the processing in the test mode upon selecting the track with the offset deviation larger than or equal to the threshold A from among the tracks on which the offset read processing is performed in the normal mode. The controller 30 in the test mode measures the offset deviation of the selected track as well as the neighboring track, and identifies the track having the abnormal track pitch on the basis of the measured offset deviation. That is, the result of the offset read processing performed in the normal mode can be used to narrow down the tracks on which the processing in the test mode is to be performed. This allows one to efficiently identify the track having the abnormal pitch compared to a case where the processing in the test mode is performed on all the tracks.

Moreover, in the aforementioned embodiment, the controller 30 of the magnetic disk device 100 identifies in the test mode whether the offset deviation is oriented in a first direction toward the center of the magnetic disk 11 or a second direction away from the center of the magnetic disk 11. When the offset deviation is oriented in the first direction, the controller 30 measures the offset deviation of a plurality of tracks that is selected by shifting one track in the second direction. When the offset deviation is oriented in the second direction, the controller 30 measures the offset deviation of a plurality of tracks that is selected by shifting one track in the first direction. One can narrow down the direction in which the measurement target is to be shifted according to the direction of the offset deviation, and can thus efficiently identify the track having the abnormal pitch.

Moreover, in the aforementioned embodiment, the controller 30 of the magnetic disk device 100 in the test mode selectively decreases the refresh threshold of the track having the abnormal pitch as well as the tracks before and after that track. This can avoid frequent triggering of the refresh operation performed on the track having a normal pitch so that the degradation in performance of the magnetic disk device 100 can be kept to the minimum.

Moreover, in the aforementioned embodiment, the controller 30 of the magnetic disk device 100 in the test mode changes the amount of reduction of the refresh threshold according to the offset deviation. The amount of reduction of the refresh threshold for the track having large offset deviation is larger than the amount of reduction of the refresh threshold for the track having small offset deviation, for example. This can prevent a read error in the read operation before the refresh operation and an increase in the frequency of the refresh operation as compared to a case where the refresh threshold of the track having the abnormal pitch is decreased evenly by the same amount.

It should be noted that, while the processing in the test mode (S8) in FIG. 5 is performed on idle when the request from the host computer 40 is not executed in order to not affect the performance of the magnetic disk device 100, the processing may interrupt the request from the host computer 40 when it is close to the refresh threshold (trigger condition).

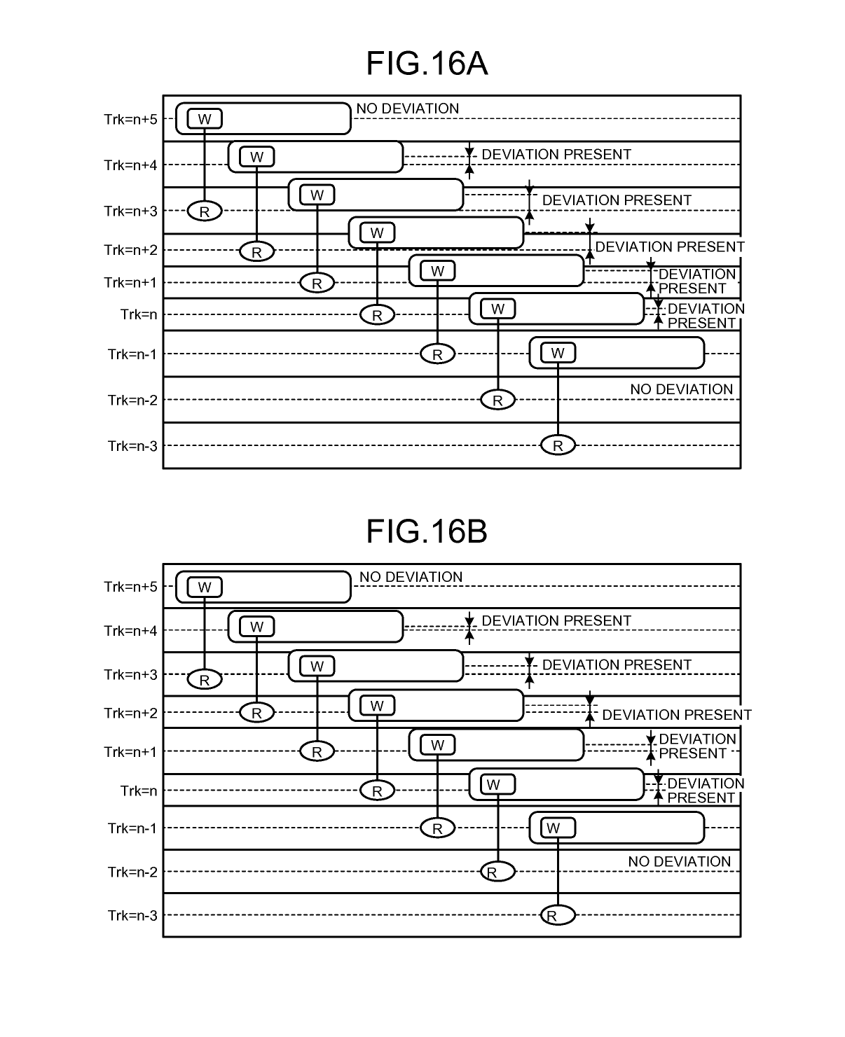

Moreover, as illustrated in FIGS. 16A and 16B, a plurality of tracks may be identified as tracks having an abnormal track pitch in the processing of identifying the track having the abnormal pitch. In step S41 illustrated in FIG. 10, for example, the controller 30 can identify as the track having the abnormal track pitch a plurality of tracks corresponding to the number of tracks shifted until the offset deviation becomes smaller than or equal to the threshold and measured just before the offset deviation becomes smaller than or equal to the threshold.

As illustrated in FIG. 16A, for example, the deviations in both ‘+ direction’ and ‘− direction’ are measured for the tracks “n+2”, “n+1” and “n” on which the offset read processing is performed. As illustrated in FIG. 16A, the offset deviation is larger than the threshold (“deviation present”) when at least a part of a virtual line segment connecting the read head 212b and the write head 22a overlaps with any of the tracks “n+2” to “n” having the abnormal pitch, while the offset deviation is smaller than or equal to the threshold (“no deviation”) when the virtual line segment connecting the read head 212b and the write head 22a does not overlap with any of the tracks “n+2” to “n” having the abnormal pitch. As a result, the tracks “n+2” to “n” can be identified as the tracks having the abnormal pitch. The controller 30 also refers to the refresh threshold management information 27c and decreases the refresh threshold of the tracks “n” to “n+2” having the abnormal pitch as well as the tracks “n−1” and “n+3” before and after these tracks according to the offset deviation for each track.

Moreover, as illustrated in FIG. 16B, the deviation of the tracks “n+2” and “n” on which the offset read processing is performed may be measured in both ‘+ direction’ and ‘−direction’. As illustrated in FIG. 16B, the deviation is larger than the threshold (“deviation present”) when at least a part of the virtual line segment connecting the read head 212b and the write head 22a overlaps with any of the tracks “n+2” and “n” having the abnormal pitch, while the deviation is smaller than or equal to the threshold (“no deviation”) when the virtual line segment connecting the read head 212b and the write head 22a does not overlap with any of the tracks “n+2” and “n” having the abnormal pitch. As a result, the tracks “n+2” to “n” can be identified as the tracks having the abnormal pitch. Here, the track “n+1” having the normal pitch between the tracks “n+2” and “n” is identified as the track having the abnormal pitch, which does not affect the operation since another track having a normal pitch is treated as a track having a normal pitch. The controller 30 also refers to the refresh threshold management information 27c and decreases the refresh threshold of the tracks “n” to “n+2” having the abnormal pitch as well as the tracks “n−1” and “n+3” before and after these tracks according to the offset deviation for each track.

The refresh thresholds of the tracks having the abnormal pitch as well as the tracks before and after these tracks are selectively decreased when the plurality of tracks having the abnormal pitch is present successively or almost successively, so that the frequent triggering of the refresh operation on the track having a normal pitch can be avoided and thus the degradation in performance of the magnetic disk device 100 can be kept to the minimum. Moreover, the amount of reduction of the refresh threshold is changed according to the offset deviation for each of the tracks having the abnormal pitch and the tracks before and after these tracks. This can prevent the read error in the read operation before the refresh operation and the increase in the frequency of the refresh operation as compared to the case where the refresh threshold of the track having the abnormal pitch is decreased evenly by the same amount.

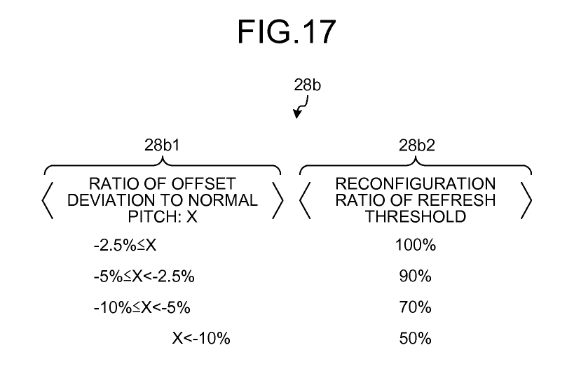

In step S13 illustrated in FIG. 9, the controller 30 may determine the reconfiguration amount corresponding to the amount of change of the track having the abnormal pitch by referring to refresh threshold reconfiguring information 28b illustrated in FIG. 17 instead of the refresh threshold reconfiguring information 28a.

The refresh threshold reconfiguring information 28b is information provided to manage a reconfiguration ratio of the refresh threshold corresponding to the offset deviation. The refresh threshold reconfiguring information 28b has a data structure illustrated in FIG. 17, for example. The refresh threshold reconfiguring information 28b includes a column “ratio of offset deviation to normal pitch” 28b1 and a column “reconfiguration ratio of refresh threshold” 28b2. A ratio of change to be adopted when reconfiguring the refresh threshold is recorded under the column “reconfiguration ratio of refresh threshold” 28b2.

The controller 30 refers to the abnormal pitch management information 27d and grasps that the offset deviation of the track “n” equals dₙ, for example. The controller 30 finds the ratio of the offset deviation to the normal pitch (dₙ/g) and refers to the refresh threshold reconfiguring information 28b. Upon recognizing the ratio “−5%≦(ΔPn/g)<−2.5%”, the controller 30 determines the reconfiguration ratio to be “90%”. The controller 30 accesses the refresh threshold management information 27c and overwrites/updates the refresh threshold of the track “n” with “Nth×0.90” in place of “Nth”. The controller 30 as a result reconfigures the refresh threshold of the track “n” to “Nth×0.90”.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

1. A magnetic disk device comprising:
a magnetic disk;
a magnetic head including a write head and a read head; and
a controller configured to obtain a difference amount for each of a first track and a second track near the first track on the magnetic disk, the difference amount being a difference between an actual read/write offset and a predetermined read/write offset, the predetermined read/write offset being set as an amount corresponding to a distance between the write head and the read head in a cross track direction, and to identify a track having an abnormal track pitch based on the obtained difference amount.

2. The magnetic disk device according to claim 1, wherein
the controller positions the read head at a position corresponding to the read/write offset set for the first track, uses the write head to write data on the first track, measures the actual read/write offset based on quality of a read signal acquired when causing the read head to read the data written on the first track while shifting the read head in the cross track direction on the first track, and calculates, as the difference amount, a difference between the measured actual read/write offset and the predetermined read/write offset.

3. The magnetic disk device according to claim 1, wherein
the controller uses the write head to write data on a track of the magnetic disk, performs offset read processing of causing the read head to read data by shifting the read head in the cross track direction when the read head fails to read data while positioned at a particular position on the track, and selects, as the first track, a track that can be read when an amount of shift in the cross track direction is larger than or equal to a first threshold.

4. The magnetic disk device according to claim 3, wherein
the controller identifies whether a direction of the shift by which read can be performed in the cross track direction corresponds to a first direction toward a center of the magnetic disk or a second direction away from the center of the magnetic disk, and when the direction of the shift corresponds to the first direction, measures the difference amount for a plurality of tracks selected by shifting one track from the first track in the second direction.

5. The magnetic disk device according to claim 4, wherein
the controller identifies, as a track having an abnormal track pitch, a track measured just before the difference amount becomes smaller than or equal to a second threshold from among the plurality of measured tracks.

6. The magnetic disk device according to claim 3, wherein
the controller identifies whether a direction of the shift by which read can be performed in the cross track direction corresponds to a first direction toward a center of the magnetic disk or a second direction away from the center of the magnetic disk, and when the direction of the shift corresponds to the second direction, measures the difference amount for a plurality of tracks selected by shifting one track from the first track in the first direction.

7. The magnetic disk device according to claim 6, wherein
the controller identifies, as a track having an abnormal track pitch, a track measured just before the difference amount becomes smaller than or equal to a second threshold from among the plurality of measured tracks.

8. The magnetic disk device according to claim 3, wherein
the controller measures the difference amount for a plurality of tracks selected by shifting one track from the first track in both directions of the cross track direction, and identifies, as a track having an abnormal track pitch, a plurality of tracks measured just before the difference amount becomes smaller than or equal to a second threshold.

9. The magnetic disk device according to claim 1, wherein
the controller reconfigures a refresh threshold from a preset first count to a second count less in number than the first count, the refresh threshold being used when performing refresh processing on each of the identified track and tracks on both side of the identified track.

10. The magnetic disk device according to claim 9, wherein
the controller changes an amount of reduction of the refresh threshold according to the difference amount.

11. A magnetic disk device comprising:
a magnetic disk including a plurality of tracks; and
a controller configured to perform refresh threshold of processing on a particular track among the plurality of tracks based on a first refresh threshold, a track pitch of the particular track being different from a track pitch of another track among the plurality of tracks, the first refresh threshold being smaller than a second refresh threshold of the another track.

12. A control method comprising:
obtaining a difference amount for each of a first track and a second track near the first track on a magnetic disk, the difference amount being a difference between an actual read/write offset and a predetermined read/write offset, the predetermined read/write offset being set as an amount corresponding to a distance between a write head and a read head in a cross track direction; and
identifying a track having an abnormal track pitch based on the obtained difference amount.

13. The control method according to claim 12, wherein
the measuring comprises:
positioning the read head at a position corresponding to the read/write offset set for the first track and writing data by the write head on the first track;
measuring the actual read/write offset based on quality of a read signal acquired when causing the read head to read the data written on the first track while shifting the read head in the cross track direction on the first track; and
calculating, as the difference amount, a difference between the measured actual read/write offset and the predetermined read/write offset.

14. The control method according to claim 12, further comprising:
writing data on a track of the magnetic disk by the write head;
performing offset read processing of causing the read head to read data by shifting the read head in the cross track direction when the read head fails to read data while positioned at a particular position on the track; and
selecting, as the first track, a track that can be read when an amount of shift in the cross track direction is larger than or equal to a first threshold.

15. The control method according to claim 14, wherein
the measuring comprises:
identifying whether a direction of the shift by which read can be performed in the cross track direction corresponds to a first direction toward a center of the magnetic disk or a second direction away from the center of the magnetic disk; and
measuring the difference amount for a plurality of tracks selected by shifting one track from the first track in the second direction when the direction of the shift corresponds to the first direction.

16. The control method according to claim 15, wherein
the identifying comprises identifying, as a track having an abnormal track pitch, a track measured just before the difference amount becomes smaller than or equal to a second threshold from among the plurality of measured tracks.

17. The control method according to claim 14, wherein
the measuring comprises:
identifying whether a direction of the shift by which read can be performed in the cross track direction corresponds to a first direction toward a center of the magnetic disk or a second direction away from the center of the magnetic disk; and
measuring the difference amount for a plurality of tracks selected by shifting one track from the first track in the first direction when the direction of the shift corresponds to the second direction.

18. The control method according to claim 17, wherein
the identifying comprises identifying, as a track having an abnormal track pitch, a track measured just before the difference amount becomes smaller than or equal to a second threshold from among the plurality of measured tracks.

19. The control method according to claim 14, wherein
the measuring comprises measuring the difference amount for a plurality of tracks selected by shifting one track from the first track in both directions of the cross track direction, and
the identifying comprises identifying, as a track having an abnormal track pitch, a plurality of tracks measured just before the difference amount becomes smaller than or equal to a second threshold.

20. The control method according to claim 12, further comprising
reconfiguring a refresh threshold from a preset first count to a second count less in number than the first count, the refresh threshold being used when performing refresh processing on each of the identified track and tracks on both side of the identified track.
